(19) United States
(12) Patent Application Publication
(10) Pub. No.: US 2018/0015815 A1
(43) Pub. Date: Jan. 18, 2018

(54) TWO-MOTOR VEHICLE DRIVE DEVICE

(71) Applicant: NTN CORPORATION, Osaka (JP)

(72) Inventors: Tomoaki MAKINO, Shizuoka (JP); Ryou YUKISHIMA, Shizuoka (JP)

(21) Appl. No.: 15/546,520

(22) PCT Filed: Jan. 21, 2016
(86) PCT No.: PCT/JP2016/051635

§ 371 Date: Jul. 26, 2017

(30) Foreign Application Priority Data
Feb. 19, 2015 (JP) 2015-030835

(51) Int. Cl. B60K 1/02; H02K 7/00; H02K 5/10; B60K 7/00; F16H 57/029; B60K 17/14; F16H 1/06; H02K 7/116; F16H 57/04; F16H 57/021

(52) U.S. Cl. CPC B60K 1/02; H02K 7/116; H02K 7/003; H02K 5/10; F16H 57/043; B60K 7/0007; F16H 57/029; B60K 17/14; F16H 1/06; B60K 2007/0092; F16H 57/021

(57) ABSTRACT

A two-motor vehicle-driving apparatus is provided where the size of speed reducers in a radial direction is small. A motor shaft of the electric motor has an axial-through hollow structure. The motor shaft is provided with an input gear integrally therewith at its end closer to the speed reducer, with an output shaft provided inside the hollow motor shaft coaxially therewith. The output shaft has an output gear integrally therewith at its end closer to the speed reducer. The speed reducer is provided with one or more intermediate shafts rotatably in parallel with the motor shaft and the output shaft. The intermediate shaft is provided with a plurality of gears integrally therewith for engagement with the input gear of the motor shaft and with the output gear of the output shaft to transmit rotation of the motor shaft to the output shaft at a reduced speed.

### TECHNICAL FIELD

The present invention relates to a two-motor vehicle-driving apparatus to be mounted above vehicle springs, including two electric motors each for driving one of a left and a right driving wheels of the vehicle independently from each other, and speed reducers.

### BACKGROUND ART

Patent Literature 1 and Patent Literature 2 disclose two-motor vehicle-driving apparatuses, each composed of: two electric motors each for driving one of a left and a right driving wheels independently from each other, and speed reducers.

A two-motor vehicle-driving apparatus of this kind, which has electric motors for driving each of the left and the right driving wheels independently, provides an advantage over a case where driving power from a single electric motor is divided to left and right for driving the left and the right wheels, that the apparatus can provide two times the power and therefore the electric motors can be smaller and lighter.

Also, a two-motor vehicle-driving apparatus provides another advantage that unlike a one-motor vehicle-driving apparatus in which a single electric motor must drive both the left and the right driving wheels, it does not require differential gears and others for dividing the driving power from a single electric motor to left and right.

### CITATION LIST

### Patent Literature

Patent literature 1: JP-A 2010-48379 Gazette

Patent literature 2: JP-A H11-243664 Gazette

### SUMMARY OF INVENTION

### Technical Problem

A conventional two-motor vehicle-driving apparatus such as disclosed in Patent Literature 1 or Patent Literature 2 includes, as shown in FIG. 5 and FIG. 6, electric motors 101L, 101R each for independently driving one of the left and right driving wheels; and speed reducers 102L, 102R each for reducing rotation speed of a corresponding one of the electric motors 101L, 101R.

As shown in FIG. 5 and FIG. 6, each of the speed reducers 102L, 102R is provided by a parallel-shaft gear speed reducer in which an input shaft 123 having an input gear for receiving driving power from a motor shaft 112 and an output shaft 125 for transmitting the driving power to the driving wheel via a drive shaft 116 are disposed in parallel with each other in an offset fashion.

Between the input shaft 123 and the output shaft 125 in each of the speed reducers 102L, 102R, one or more intermediate shaft(s) 124 (counter shaft(s)) are provided.

The above-described disposition, in which the motor shaft 112 and the output shaft 125 are parallel with each other and offset from each other, increases the size of the speed reducers 102L, 102R in radial directions, resulting in increased mass of the two-motor vehicle-driving apparatus and decreased mountability onto the vehicle.

Patent Literature 2 discloses a two-motor vehicle-driving apparatus shown in FIG. 6, where motor shafts 112 of the electric motors 101L, 101R and input shafts 123 of the speed reducers 102L, 102R are separate members from each other, each of these shafts is individually supported with bearings, and an oil seal 126 is provided between the motor shaft 112 and a casing. The arrangement has a problem that it increases an axial dimension of the two-motor vehicle-driving apparatus. Although the oil seals 126 are useful in preventing lubricant, which provides lubrication of gears in the speed reducers 102L, 102R, from entering inside the electric motors 101L, 101R, the oil seal 126 has an oil seal lip which makes contact with the motor shaft 112 that is a part which has the fastest rotating speed. This decreases transmission efficiency of the two-motor vehicle-driving apparatus while increasing risk for damage, such as wear and burn of the oil seal lip.

It is therefore an object of the present invention to provide a two-motor vehicle-driving apparatus in which the size of the speed reducers in radial direction is small, the speed reducers require a minimum number of oil seals to seal the lubricant filled in the speed reducers, and the oil seal makes contact only with the slowest rotating shafts.

### Solution to Problem

In order to solve the above-described problems, the present invention provides a two-motor vehicle-driving apparatus including: two electric motors for driving a left and a right wheels respectively; and two speed reducers for reducing motor rotation of respective electric motors. The two electric motors are disposed at locations closer to the respective wheels relative to the speed reducers. With the above arrangement, a motor shaft of the electric motor has an axial-through hollow structure. The motor shaft is provided with an input gear integrally therewith at its end closer to the speed reducer, with an output shaft provided inside the hollow motor shaft coaxially therewith. The output shaft has an output gear integrally therewith at its end closer to the speed reducer. The speed reducer is provided with one or more intermediate shafts rotatably in parallel with the motor shaft and the output shaft, and the intermediate shaft(s) are provided with a plurality of gears integrally therewith for engagement with the input gear of the motor shaft and with the output gear of the output shaft to transmit rotation of the motor shaft to the output shaft at a reduced speed.

### Advantageous Effects of Invention

According to the present invention, by providing the output shaft inside the hollow motor shaft coaxially therewith as described above, it is possible to decrease the size of the speed reducer in its radial direction.

Also, With an arrangement that the output shaft, which is disposed inside the hollow motor shaft coaxially therewith, has its end extending out of an opening in an outboard wall of a motor casing which houses the electric motor; and sealing is provided between the output shaft and the motor casing by an oil seal, it is possible to minimize the number of oil seals to seal lubricant filled in the speed reducer, and to provide a structure where the oil seal makes contact only with the slowest rotating shaft.

All of the gears inside the speed reducer are provided by external gears. This makes it possible to provide lubrication by splashing lubricant with gears from a bottom reservoir in an inside space of the speed reducer.

The output shaft is formed, inside therein, with an axial oil path which has an opening on a side closer to the speed reducer (inboard side of the apparatus). Further, one or more radial oil paths are formed to provide communication between the axial oil path and an outer circumferential regions near a bearing which supports the output shaft. The above arrangement makes it possible that lubricant, which follows wall surfaces of the speed reducer casing and enters the inside space of the output shaft, is carried centrifugally to near the bearings through the radial oil paths by the rotation of the output shaft. The arrangement makes it possible to prevent damage on the bearings and the oil seals which are disposed at the outboard end regions.

### BRIEF DESCRIPTION OF DRAWINGS

FIG. 1 is a cross-sectional plan view which shows an embodiment of a two-motor vehicle-driving apparatus according to the present invention.

FIG. 2 is a cross-sectional plan view which shows an enlarged portion of FIG. 1.

FIG. 3 is a sectional view taken in lines in FIG. 1.

FIG. 4 is a schematic plan view which shows an electric vehicle mounted with the two-motor vehicle-driving apparatus according to the present invention.

FIG. 5 is a cross-sectional plan view which shows a conventional two-motor vehicle-driving apparatus.

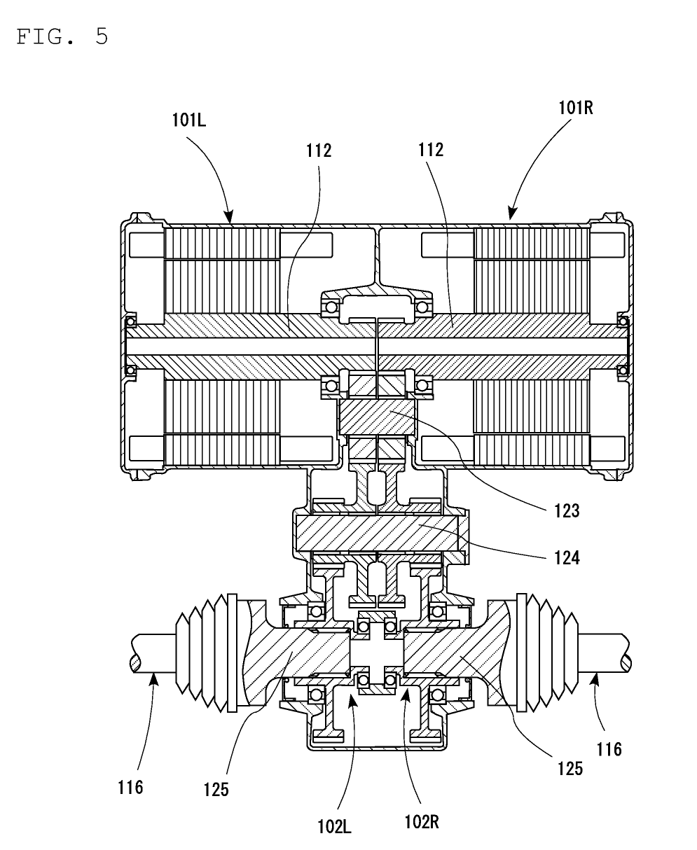

FIG. 6 is a cross-sectional plan view which shows another conventional two-motor vehicle-driving apparatus.

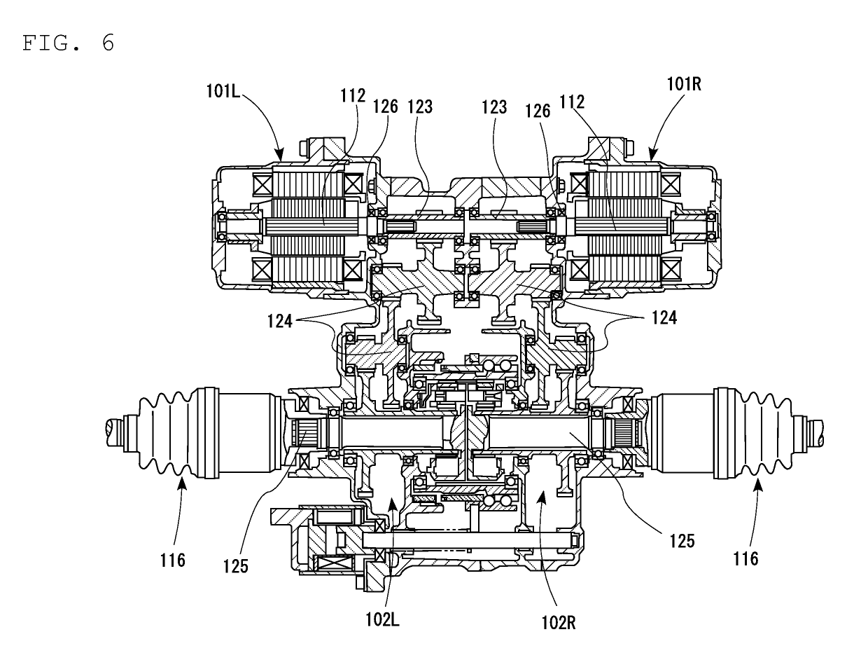

### DESCRIPTION OF EMBODIMENTS

Hereinafter, embodiments of the present invention will be described based on the attached drawings.

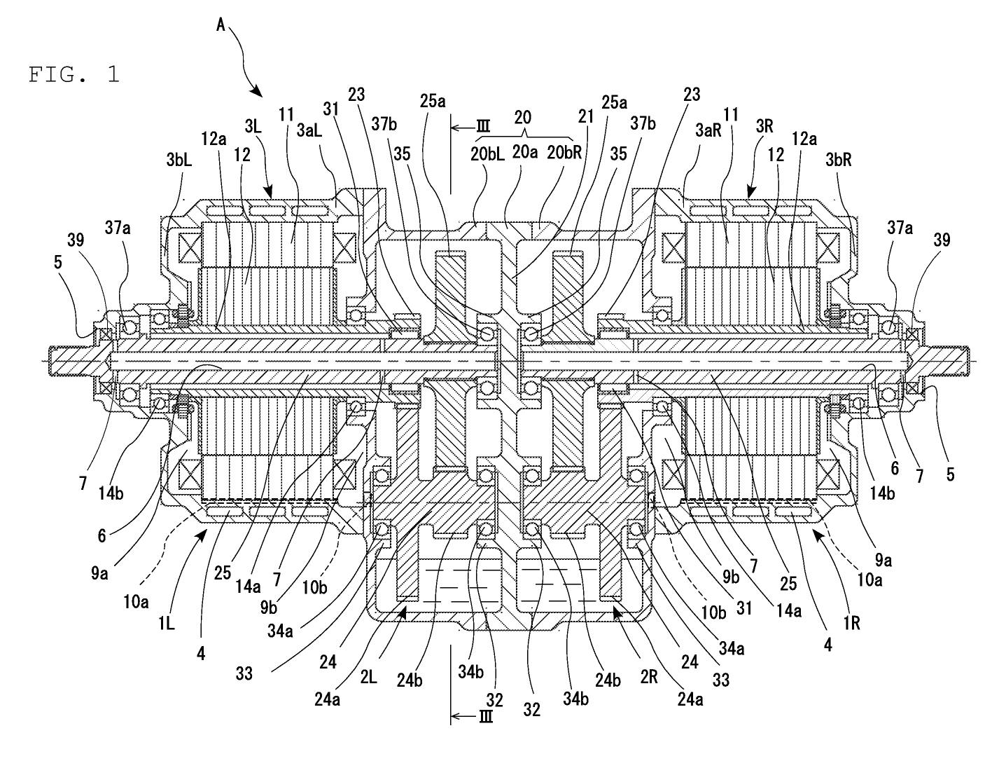

As shown in FIG. 1, a two-motor vehicle-driving apparatus A according to the present invention utilizes a structure that a speed reducer casing 20, which houses two speed reducers 2L, 2R provided side by side on left and right, is disposed at a center; and motor casings 3L, 3R of two electric motors 1L, 1R are fixed to a left side and a right side respectively of the speed reducer casing 20.

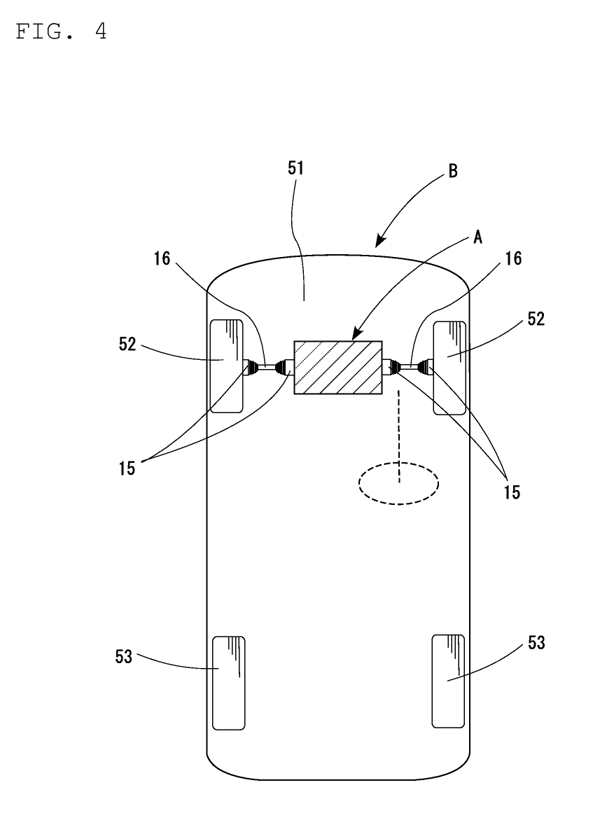

As shown in FIG. 4, an electric vehicle B according to the present invention includes a chassis 51; front wheels 52 as driving wheels; rear wheels 53; and the two-motor vehicle-driving apparatus A which drives the left and the right front wheels 52 independently from each other. The two-motor vehicle-driving apparatus A is mounted on the chassis 51, at a center position between the left and the right front wheels 52. Driving power from the two-motor vehicle-driving apparatus A are transmitted to the left and the right front wheels 52 via constant velocity joints 15 and drive shafts 16.

The two-motor vehicle-driving apparatus A may be utilized in whichever of a front-wheel driving method as shown in FIG. 4, a rear-wheel drive method and a four-wheel drive method.

As shown in FIG. 1, the speed reducer casing 20, which houses the two speed reducers 2L, 2R provided side by side on left and right, has a three-piece structure, including a center casing 20a, and a left and a right side casings 20bL, 20bR which are fixed to respective sides of the center casing 20a.

As shown in FIG. 1, the left and the right electric motors 1L, 1R in the two-motor vehicle-driving apparatus A according to the present invention are housed in the motor casings 3L, 3R.

The motor casings 3L, 3R respectively have cylindrical motor casing main bodies 3aL, 3aR, and outboard walls 3bL, 3bR which close outboard side faces of the motor casing main bodies 3aL, 3aR. Each of the outboard walls 3bL, 3bR is provided with an opening 5 for an output shaft 25, which will be described later, to extend therefrom. Also, inboard faces of the motor casing main bodies 3aL, 3aR, which are close to the respective speed reducers 2L, 2R are closed by the side casings 20bL, 20bR of the speed reducer casing 20.

The motor casing main bodies 3aL, 3aR are provided with cooling piping 4, and the piping 4 is supplied with coolant from a radiator (not illustrated). The piping 4 constitutes so called water jacket, whereby the electric motors 1L, 1R are effectively cooled.

As shown in FIG. 1, the electric motors 1L, 1R are provided by radial gap motors wherein each of the motor casing main bodies 3aL, 3aR has their inner circumferential surface provided with a stator 11, and the stator 11 has its inner circumference provided with a rotor 12 at a distance.

The rotor 12 has a motor shaft 12a at its center. The motor shaft 12a has an axial-through hollow structure, and each motor shaft 12a has an end penetrating corresponding one of the side casings 20bL, 20bR of the speed reducer casing 20, and inserted into the speed reducer casing 20. The end of the motor shaft 12a inside the speed reducer casing 20 has its outer circumferential surface provided with an input gear 23.

In the embodiment in FIG. 1, the input gear 23 is formed integrally with the motor shaft 12a, at an end thereof, on an outer circumferential surface thereof; however, the input gear 23 may be fitted around the motor shaft 12a by means of splines for example.

The motor shafts 12a are rotatably supported by the outboard walls 3bL, 3bR of the motor casings 3L, 3R and the side casings 20bL, 20bR of the speed reducer casing 20 via rolling bearings 14a, 14b (FIG. 1).

Inside the hollow motor shaft 12a, an output shaft 25 is disposed coaxially therewith.

The output shaft 25 has a large-diameter output gear 25a inside the speed reducer casing 20, and is rotatably supported by the opening 5 in a corresponding one of the outboard walls 3bL, 3bR of the motor casings 3L, 3R and a boss portion 35 formed on both surfaces of a partition wall 21 of the center casing 20a, via rolling bearings 37a, 37b. The output gear 25a is spline-connected to the output shaft 25.

On an outside of each of the rolling bearings 37a, 37 which support the output shaft 25 rotatably, an oil seal 39 is provided for sealing between the output shaft 25 and the opening 5 in each of the outboard walls 3bL, 3bR of the motor casings 3L, 3R.

As shown in FIG. 4, the output shaft 25 has its outboard end region fitted with a constant velocity joints 15, for transmission of driving power to the wheel 52 via a drive shaft 16.

If there is a wide interval between the two rolling bearings 37a, 37b which support the output shaft 25 at its ends, the output shaft 25 tends to deflect excessively, potentially affecting durability of the gear and vibration characteristics. With this in mind, for reduced deflection of the shaft by increasing support rigidity of the output shaft 25, a support bearing 31 is provided on an inner circumferential region inside the hollow motor shaft 12a for supporting the output shaft 25 with respect to the motor shaft 12a.

The support bearing 31 is provided by a cylindrical roller bearing. Also, in FIG. 1, the support bearing 31 rotatably supports the output shaft 25 on an inner circumferential side of the input gear 23. The arrangement is effective in not adversely affecting the input gear 23 in terms of durability and vibration characteristics.

In the embodiment described above, the support bearing 31 is provided by a cylindrical roller bearing; however, this is not limiting. For example, slide bearing, deep groove ball bearing, tapered roller bearing, needle roller bearing, self-aligning roller bearing, angular contact ball bearing, four-point contact ball bearing, and any other type, whether it is a slide bearing or a rolling bearing, or whether their rolling elements are rollers or balls, or whether the bearing is a single-row type or a double-row type, is applicable. Likewise, any of the bearings disposed in other locations may be provided by whatsoever type.

One of the support bearing 31 and the rolling bearings 37a, 37b of the output shaft 25 may be eliminated if the elimination still ensures satisfactory support rigidity.

Each of the speed reducers 2L, 2R is provided with one or more intermediate shafts 24 rotatably in parallel with the motor shaft 12a and the output shaft 25. The intermediate shaft 24 is provided with a plurality of gears integrally therewith, and these gears engage with the input gear 23 of the motor shaft 12a and the output gear 25a of the output shaft 25, to slow rotation of the motor shaft 12a before the rotation is transmitted to the output shaft 25.

The intermediate shaft 24 is provided by a stepped gear which has, on its outer circumferential surface, a large-diameter gear 24a for engagement with the input gear 23, and a small-diameter gear 24b for engagement with the output gear 25a. The intermediate shaft 24 is supported, at its two ends, by a boss portion 32 formed in each surface of the partition wall 21 of the center casing 20a and by a boss portion 33 formed in each of the side casings 20bL, 20bR, via rolling bearings 34a, 34b.

All gears inside the speed reducer casing 20 are provided by external gears, and these gears and bearings inside the speed reducer casing 20 are lubricated by splashing lubricant with gears from a bottom reservoir in the inside space of the speed reducer casing 20.

Further, for sufficient lubrication of the rolling bearings 14a, 14b, 37a and the oil seals 39 provided at the outboard end regions of the motor casings 3L, 3R, lubricant is supplied from an axial center of the output shaft 25.

Specifically, the output shaft 25 is formed, inside thereof, with an axial oil path 6 opening at the side of the speed reducer casing 20 (inboard side of the apparatus). Further, radial oil paths 7 are formed to provide communication from the axial oil path 6 to outer circumferential regions near the rolling bearing 37a and the support bearing 31 which support the output shaft 25. Lubricant, which follows wall surfaces of the speed reducer casing and enters the inside space of the output shaft, is carried centrifugally to near the bearings through the radial oil paths by the rotation of the output shaft. This lubrication method by means of the axial oil paths 6 and the radial oil paths 7 makes it possible to prevent damage on the bearings and the oil seals 39 which are disposed at the outboard end regions.

Though not illustrated, lubricant is supplied to the axial oil path 6 with flowing down on the partition wall 21 after splashed with gears from a bottom reservoir in the inside space of the speed reducer casing 20 and then

If the lubricant which enters inside the motor casings 3L, 3R is not discharged sufficiently, oil level inside the motor casings 3L, 3R rises, resulting in increase in oil agitation loss by the rotor 12. For appropriate discharge of the lubricant from inside the motor casings 3L, 3R to the side of the speed reducer casing 20, the following structure is employed.

Inside the motor casings 3L, 3R is axially divided by the stator 11 and the rotor 12 into two spaces 9a, 9b.

An oil path which provides communication between these two spaces 9a, 9b is provided near the lowest region (Bottom Dead Center) of the stator 11. For example, an axially groove 10a is provided on an outer circumference of the stator 11 or on an inner circumference of each motor casings 3L, 3R, as the path which provides communication between the spaces 9a, 9b.

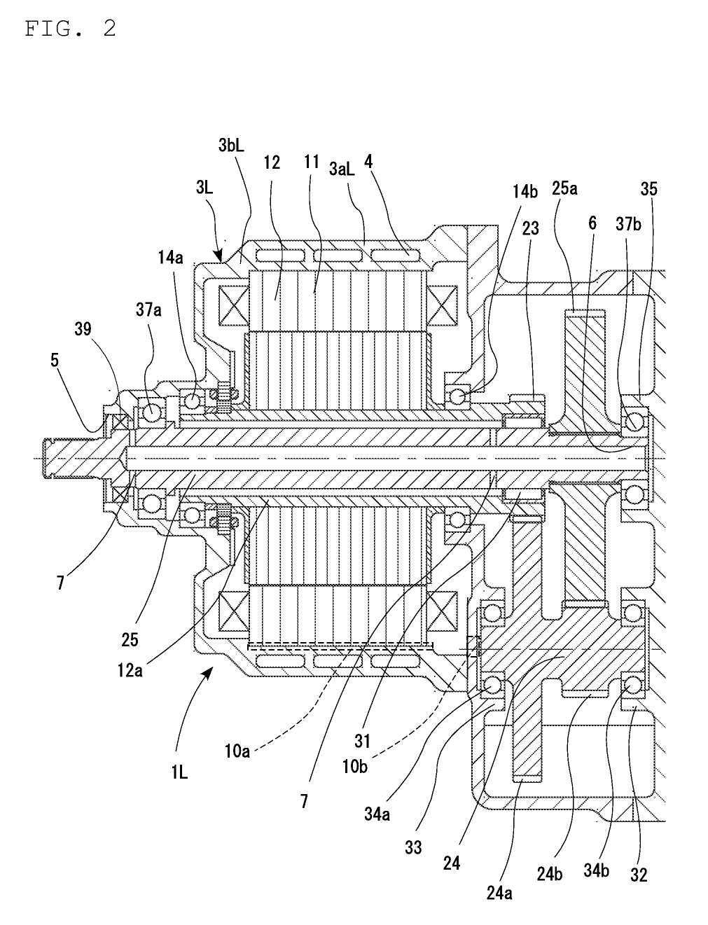

Also, a through oil path 10b is provided in each of the side casings 20bL, 20bR which separate the motor casings 3L, 3R from the speed reducer casing 20. As shown in FIG. 2, these through oil paths 10b are at a lower position than the lowest region (Bottom Dead Center) of the rotor 12.

The axial grooves 10a serving as the paths which provide communication between the spaces 9a, 9b, and the through oil paths 10b which are at a lower position than the lowest point (Bottom Dead Center) of the rotors 12 allow lubricant which is supplied to the bearings and the oil seals 39 disposed at the outboard ends to move from the spaces 9a to the spaces 9b in the motor casings 3L, 3R, and then to return into the speed reducer casing 20 without being splashed by the rotor 12.

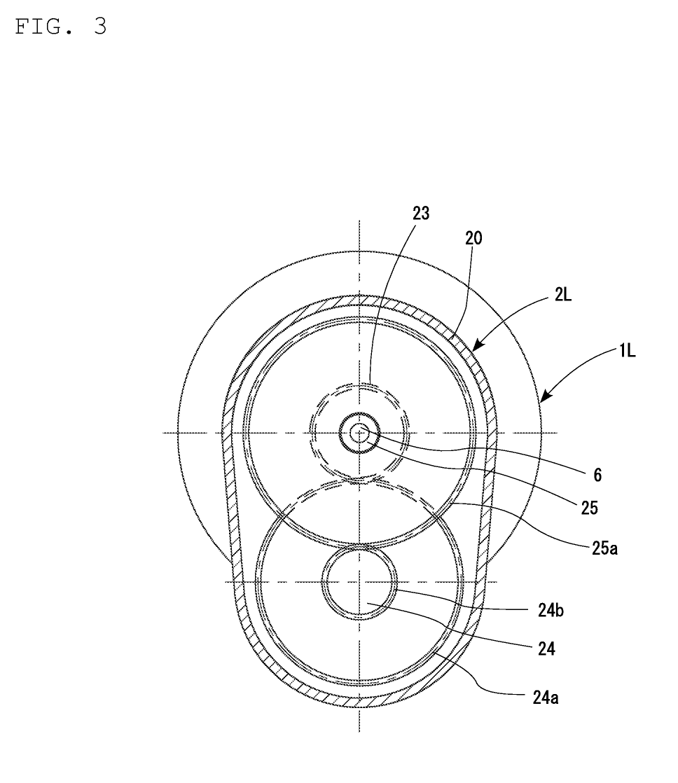

FIG. 3 is a sectional view taken in lines in FIG. 1. As shown in FIG. 3, rotation is transmitted from the input gear 23 to the large-diameter gear 24a of the intermediate shaft 24, and then from the small-diameter gear 24b of the intermediate shaft to the output gear 25a which is on the output shaft 25, whereby rotation of the electric motors 1L, 1R is slowed and transmitted to the output shafts 25, to drive the wheels 52 at a large torque. Since all of the input gear 23, the large-diameter gear 24a, the small-diameter gear 24b and the output gear 25a are provided by external gears, it is possible to provide lubrication by splashing lubricant with gears from the bottom reservoir in an inside space of the speed reducer. In addition, since external gears are easy to manufacture, it is possible to decrease cost of the two-motor vehicle-driving apparatus.

The present invention is in no way limited by the embodiments described above, and is needless to say possible to implement in various other ways within the scope of the present invention. The scope of the present invention is described by CLAIMS and includes all variation within equivalent meaning and scope of the CLAIMS.

### REFERENCE SIGNS LIST

1L, 1R: Electric Motors
2L, 2R: Speed Reducers
3L, 3R: Motor Casings
3aL, 3aR: Motor Casing Main Bodies
3bL, 3bR: Outboard Walls
4: Pipe
5: Opening
6: Axial Oil Path
7: Radial Oil Path
9a, 9b: Spaces
10a: Axially Groove
10b: Through oil path
11: Stator
12: Rotor
12a: Motor Shaft
14a, 14b: Rolling Bearings
15: Constant Velocity Joints
16: Drive Shaft
20: Speed Reducer Casing
20a: Center Casing
20bL, 20bR: Side Casings
21: Partition Wall
23: Input Gear
24: Intermediate Shaft
24a: Large-Diameter Gear
24b: Small-Diameter Gear
25: Output Shaft
25a: Output Gear
31: Support Bearing
32: Boss Portion
33: Boss Portion
34a, 34b: Rolling Bearings
35: Boss Portion
37a: Rolling Bearing
37b: Rolling Bearing
39: Oil Seal
51: Chassis
52: Front Wheel
53: Rear Wheel
A: Two-Motor Vehicle-Driving Apparatus
B: Electric Vehicle

1. A two-motor vehicle-driving apparatus comprising two electric motors for driving a left and a right wheels respectively; and two speed reducers for reducing motor rotation of the respective electric motors; the two electric motors being disposed at locations closer to the respective wheels relative to the speed reducers, wherein a motor shaft of the electric motor has an axial-through hollow structure; the motor shaft is provided with an input gear integrally therewith at its end closer to the speed reducer, with an output shaft provided inside the hollow motor shaft coaxially therewith; the output shaft has an output gear integrally therewith at its end closer to the speed reducer; the speed reducer is provided with one or more intermediate shafts rotatably in parallel with the motor shaft and the output shaft; the intermediate shaft is provided with a plurality of gears integrally therewith for engagement with the input gear of the motor shaft and with the output gear of the output shaft to transmit rotation of the motor shaft to the output shaft at a reduced speed.

2. The two-motor vehicle-driving apparatus according to claim 1, wherein the output shaft, which is disposed inside the hollow motor shaft coaxially therewith, has its end extending out of an opening in an outboard wall of a motor casing which houses the electric motor; and sealing is provided between the output shaft and the opening of the motor casing by an oil seal.

3. The two-motor vehicle-driving apparatus according to claim 1, wherein all of the gears inside the speed reducer are provided by external gears.

4. The two-motor vehicle-driving apparatus according to claim 1, wherein the output shaft is formed, inside therein, with an axial oil path which has an opening on a side closer to the speed reducer; and further with one or more radial oil paths which provide communication between the axial oil path and an outer circumference of the shaft.

5. The two-motor vehicle-driving apparatus according to claim 1, wherein electric motor's stator and rotor axially divide inside space of the motor casing; and an oil path which provides communication between the divided spaces is formed on an outer circumference of the stator or on an inner circumferential region of the motor casing where the stator is fitted.

6. The two-motor vehicle-driving apparatus according to claim 1, wherein the electric motor is housed in the motor casing whereas the speed reducer is housed in a speed reducer casing; the two casings are separated by a wall; and the wall surface is provided with a through oil path which provides communication between the motor casing and the speed reducer casing, at a lower position than a lowest portion of the rotor.
